(19) United States
(12) Patent Application Publication
(10) Pub. No.: US 2024/0138465 A1
(43) Pub. Date: May 2, 2024

(54) Apparatus for Deseeding a Sorrel Bud

(71) Applicant: Turner Innovations Ltd., Manchester (JM)

(72) Inventors: Oral Oneal Turner, Manchester (JM); Allison Deborah Turner, Manchester (JM)

(73) Assignee: Turner Innovations Ltd., Manchester (JM)

(21) Appl. No.: 18/521,971

(22) Filed: Nov. 28, 2023

Related U.S. Application Data
(63) Continuation-in-part of application No. 18/382,614, filed on Oct. 23, 2023.
(60) Provisional application No. 63/419,845, filed on Oct. 27, 2022.

(51) Int. Cl. A23N 15/04

(52) U.S. Cl. CPC A23N 15/04

(57) ABSTRACT

An apparatus for separating a calyx and a seed pod of a sorrel bud, whereby the apparatus can include a holder configured to hold the sorrel bud; a cutter movable in relation to the holder, the cutter configured to cut an opening in a base of the calyx to provide a cut calyx; and a separator movable in relation to the holder, the separator configured to separate the seed pod from the cut calyx via the opening. Movement of the cutter and the separator can be automatic.

### I. BACKGROUND OF THE INVENTION

Roselle (Hibiscus sabdariffa), also referred to as sorrel, is a species of flowering plant that is commonly grown for its vibrant red calyces, which can be used to make tea that may be consumed hot or cold and is known by various names in different regions, such as hibiscus tea, sorrel in some Caribbean countries, or agua de jamaica in Mexico.

Apart from its use in beverages, roselle has been used in traditional medicine for various purposes. The plant is rich in antioxidants, and some studies suggest potential health benefits, such as lowering blood pressure and reducing cholesterol levels. Additionally, parts of the roselle plant, including the leaves and seeds, can be used in culinary applications.

The calyx (or sepals) of a sorrel bud surround and/or enclose a large seed pod; the present method of sorrel harvesting is largely a task of manual labor using an improvised hand tool typically made from a tube having a serrated end approximately the same diameter as that of the seed pod. This serrated end is used to cut through the base of the calyx and then to push the seed pod out of the calyx, thereby separating the seed pod from the calyx.

This harvest methodology has two primary shortcomings. Firstly, the labor cost can be high since several laborers may be required to pick the sorrel buds and separate the seed pods from the calyces. Secondly, as a result of the significant amount of time required for harvesting, there may be a substantial delay before preservation and use, and during this time, the calyces can begin to break down and deteriorate. This may be especially so when handling large quantities.

Hence, an apparatus is needed to automate the separation of the seed pods from the calyces of a sorrel bud, thus reducing the amount of manual labor and the time required to efficiently harvest the sorrel.

### II. SUMMARY OF THE INVENTION

A broad object of a particular embodiment of the present invention can be to provide an apparatus for separating a calyx and a seed pod of a sorrel bud, whereby the apparatus can include a holder configured to hold the sorrel bud; a cutter movable in relation to the holder, the cutter configured to cut an opening in a base of the calyx to provide a cut calyx; and a separator movable in relation to the holder, the separator configured to separate the seed pod from the cut calyx via the opening. Movement of the cutter and the separator can be automatic.

Naturally, further objects of the invention are disclosed throughout other areas of the specification, drawings, and claims.

### III. BRIEF DESCRIPTION OF THE DRAWINGS

FIG. 1A is an illustration of a front view of a sorrel bud.

FIG. 1B is an illustration of a bottom view of a sorrel bud showing a cut calyx and a seed pod which is no longer connected to the calyx following cutting of the base of the sorrel bud with a particular embodiment of a cutter of the inventive deseeding apparatus.

FIG. 1C is an illustration of a sorrel flower.

FIG. 2A is a perspective view of a particular embodiment of the inventive deseeding apparatus.

FIG. 2B is a front view of the particular embodiment of the deseeding apparatus shown in FIG. 2A.

FIG. 2C is a rear view of the particular embodiment of the deseeding apparatus shown in FIG. 2A.

FIG. 2D is a first side view of the particular embodiment of the deseeding apparatus shown in FIG. 2A.

FIG. 2E is a second side view of the particular embodiment of the deseeding apparatus shown in FIG. 2A.

FIG. 2F is a top view of the particular embodiment of the deseeding apparatus shown in FIG. 2A.

FIG. 2G is a bottom view of the particular embodiment of the deseeding apparatus shown in FIG. 2A.

FIG. 3A is a perspective view of a particular embodiment of the inventive deseeding apparatus including the apparatus shown in FIGS. 2A through 2G which is disposed within a housing.

FIG. 3B is a front view of the particular embodiment of the deseeding apparatus shown in FIG. 3A.

FIG. 3C is a rear view of the particular embodiment of the deseeding apparatus shown in FIG. 3A.

FIG. 3D is a first side view of the particular embodiment of the deseeding apparatus shown in FIG. 3A.

FIG. 3E is a second side view of the particular embodiment of the deseeding apparatus shown in FIG. 3A.

FIG. 3F is a top view of the particular embodiment of the deseeding apparatus shown in FIG. 3A.

FIG. 3G is a bottom view of the particular embodiment of the deseeding apparatus shown in FIG. 3A.

FIG. 4A is a perspective view of a particular embodiment of the inventive deseeding apparatus.

FIG. 4B is a front view of the particular embodiment of the deseeding apparatus shown in FIG. 4A.

FIG. 4C is a rear view of the particular embodiment of the deseeding apparatus shown in FIG. 4A.

FIG. 4D is a first side view of the particular embodiment of the deseeding apparatus shown in FIG. 4A.

FIG. 4E is a second side view of the particular embodiment of the deseeding apparatus shown in FIG. 4A.

FIG. 4F is a top view of the particular embodiment of the deseeding apparatus shown in FIG. 4A.

FIG. 4G is a bottom view of the particular embodiment of the deseeding apparatus shown in FIG. 4A.

FIG. 5A is a cross section of the particular embodiment of the components of the inventive deseeding apparatus shown in FIG. 4B.

FIG. 5B is a cross section of the particular embodiment of the components of the inventive deseeding apparatus shown in FIG. 4B.

FIG. 6A is an exploded perspective view of a particular embodiment of components of the inventive deseeding apparatus.

FIG. 6B is an exploded side view of the particular embodiment of the components shown in FIG. 6A.

FIG. 7A is a front view of a particular embodiment of the inventive deseeding apparatus.

FIG. 7B is a rear view of the particular embodiment of the deseeding apparatus shown in FIG. 7A.

FIG. 7C is a first side view of the particular embodiment of the deseeding apparatus shown in FIG. 7A.

FIG. 7D is a second side view of the particular embodiment of the deseeding apparatus shown in FIG. 7A.

### IV. DETAILED DESCRIPTION OF THE PREFERRED EMBODIMENTS

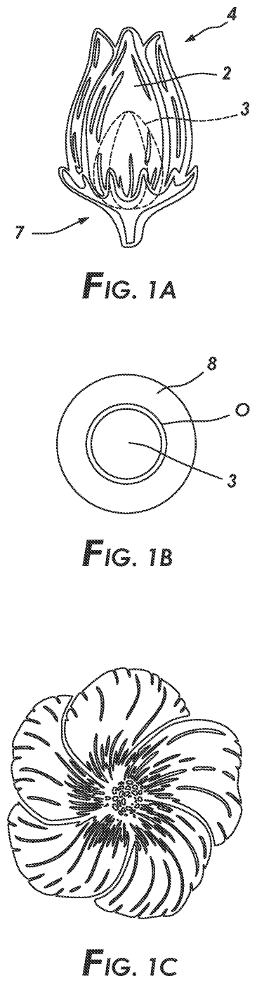

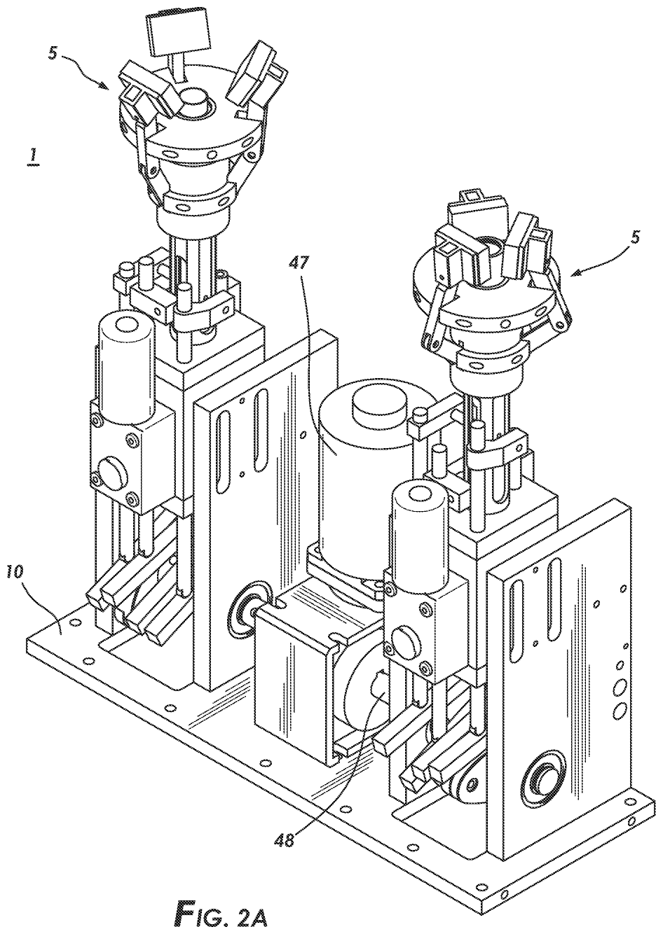

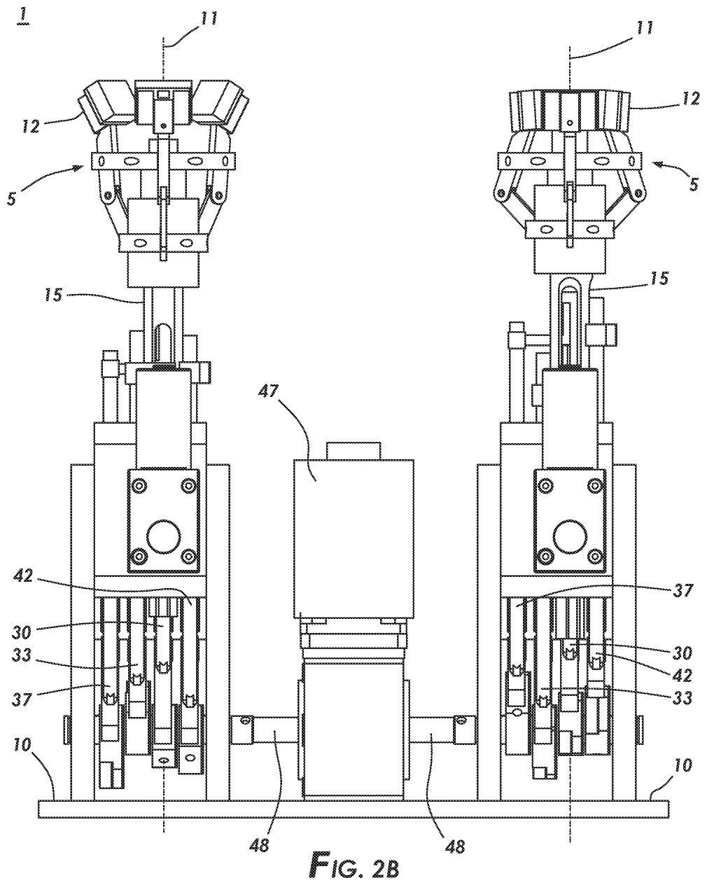

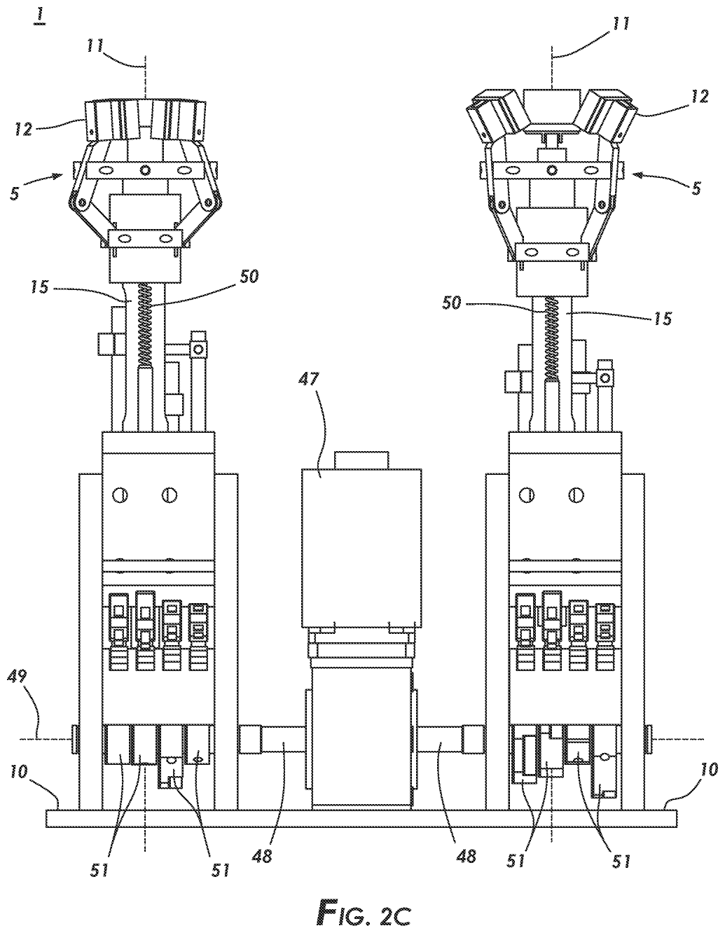

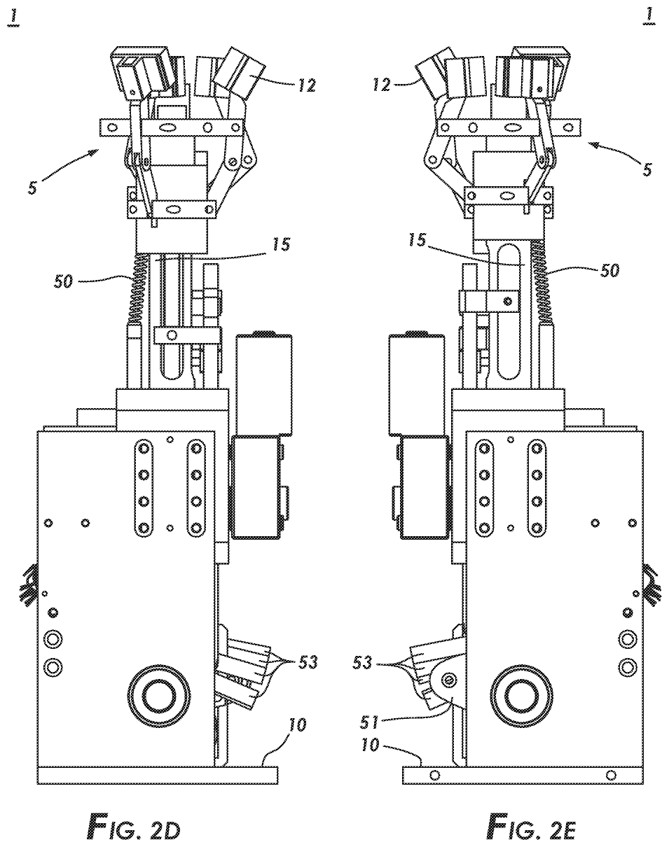

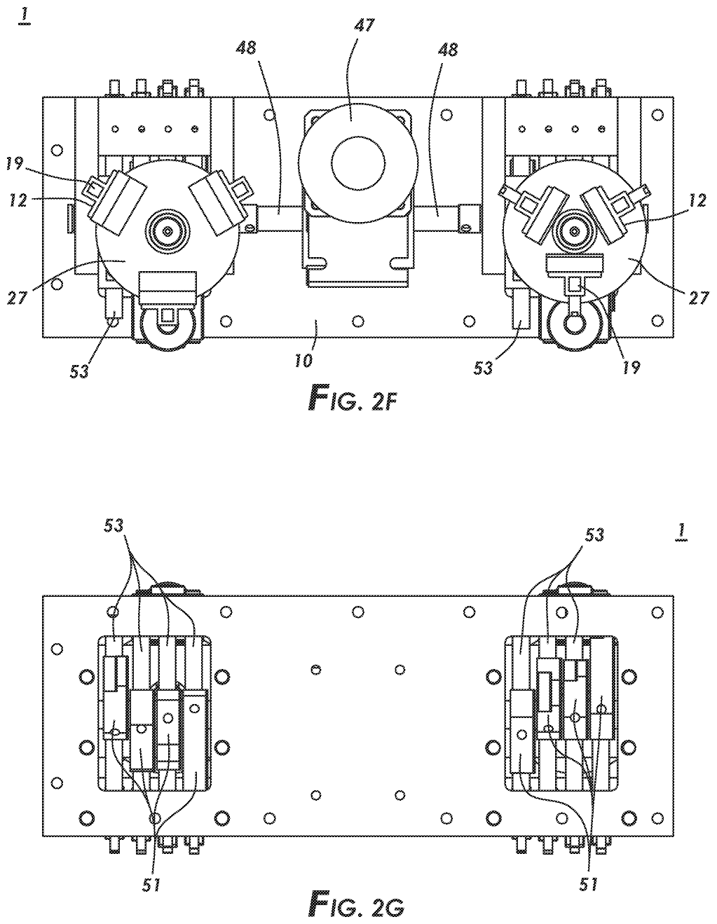

Now referring primarily to FIGS. 2A through 5B, particular embodiments of the present inventive deseeding apparatus (1) which can separate a calyx (2) and a seed pod (3) of a sorrel bud (4) (illustrated in FIGS. 1A and 1B along with a sorrel flower illustrated in FIG. 1C) are shown, whereby the apparatus (1) comprises a holder (5) configured to hold the sorrel bud (4), and a cutter (6) movable in relation to the holder (5), whereby the cutter (6) may be configured to cut an opening (O) in the base (7) of the calyx (2) to provide a cut calyx (8). Notably, the seed pod (3) can be accessible via the opening (O). The deseeding apparatus (1) further includes a separator (9) movable in relation to the holder (5), whereby the separator (9) can be configured to separate the seed pod (3) from the cut calyx (8) via the opening (O). Movement of the cutter (6) and the separator (9) can be automatic or driven by a machine, as opposed to being driven by human power (thus, manual labor).

As a frame of reference for the following description, the deseeding apparatus (1) includes a support surface (10) on which components thereof can be mounted. During operation of the deseeding apparatus (1), the support surface (10) typically remains fixed in space (or does not move), and components of the deseeding apparatus (1) move in relation to the stationary support surface (10).

As used herein, when two objects are “fixedly engaged” or “fixedly coupled” or “fixedly connected” or “fixed in relation to” one another, typically, under normal circumstances, the objects are immovable relative to one another. In contrast, as used herein, when two objects are “movably engaged” or “movably coupled” or “movably connected” or “movable in relation to” one another, typically, under normal circumstances, one object is capable of being moved (or traveling) relative to the other object.

Directional terms used herein, such as down, up, downward, upward, etc. can be in reference to the particular embodiment of the deseeding apparatus (1) shown in the accompanying Figures. Correspondingly, “down” and “downward,” as well as “beneath” and “below” and “lower,” can mean generally toward the support surface (10) on which components of the deseeding apparatus (1) are mounted, and “up” and “upward,” as well as “above” and “upper,” can mean generally the opposite thereof. Further, “horizontal” can mean generally parallel to the support surface (10), and “vertical” can mean generally orthogonal (or perpendicular or normal) to the support surface (10). Following, components of the deseeding apparatus (1) shown in the accompanying Figures which move linearly and up and/or down can be considered to move along a generally vertical axis, and components of the deseeding apparatus (1) shown in the accompanying Figures which move linearly and laterally (such as right and/or left) can be considered to move along a generally horizontal axis.

In operation, some components of the deseeding apparatus (1) can move linearly and/or reciprocally along an operating axis (11); as to the particular embodiment of the deseeding apparatus (1) shown in the accompanying Figures, the operating axis (11) may be a generally vertical axis. However, the invention need not be limited to this orientation, and other embodiments of the deseeding apparatus (1) can have some components which move linearly and/or reciprocally along an operating axis (11) which may be a generally horizontal axis or any axis angled between the horizontal and vertical axes. In addition to having some components which can move linearly and/or reciprocally, the deseeding apparatus (1) may have other components which rotate about a rotation axis, whereby as used herein, the term “rotate” and its derivatives can mean to turn or cause to turn about an axis or a center point and/or to circle around an axis or a center point. As to particular embodiments, a synonym of “rotate” can be “pivot” or “turn.”

The term “diameter” as used herein means the length of a line through the center of an object, whereby the object may but need not be a circle.

The term “circumference” as used herein means the external boundary or surface of an object, whereby the object may but need not be a circle.

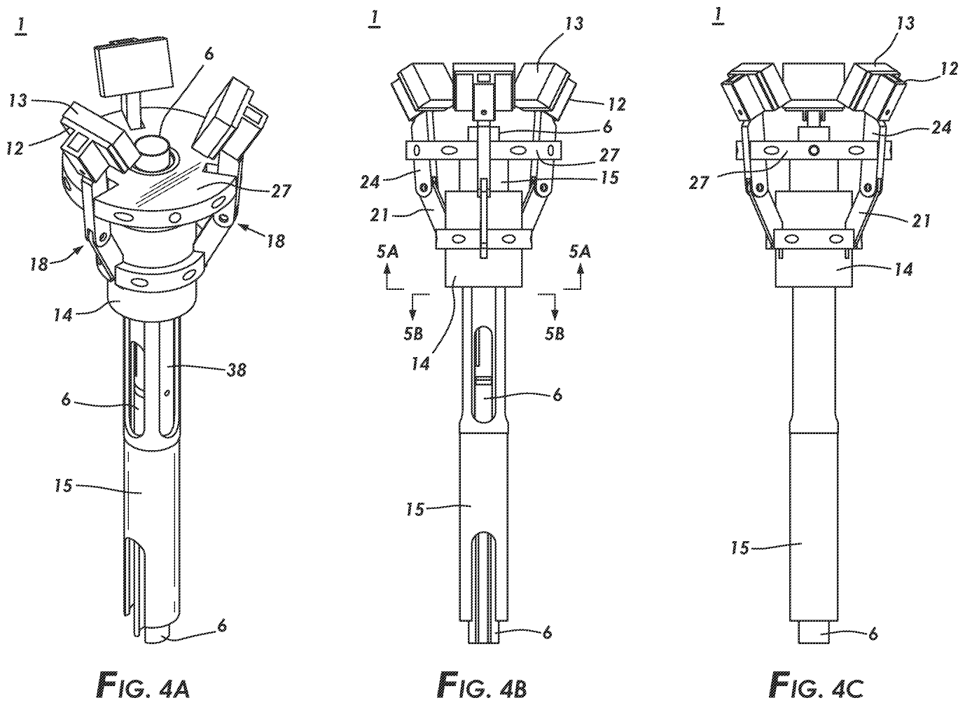

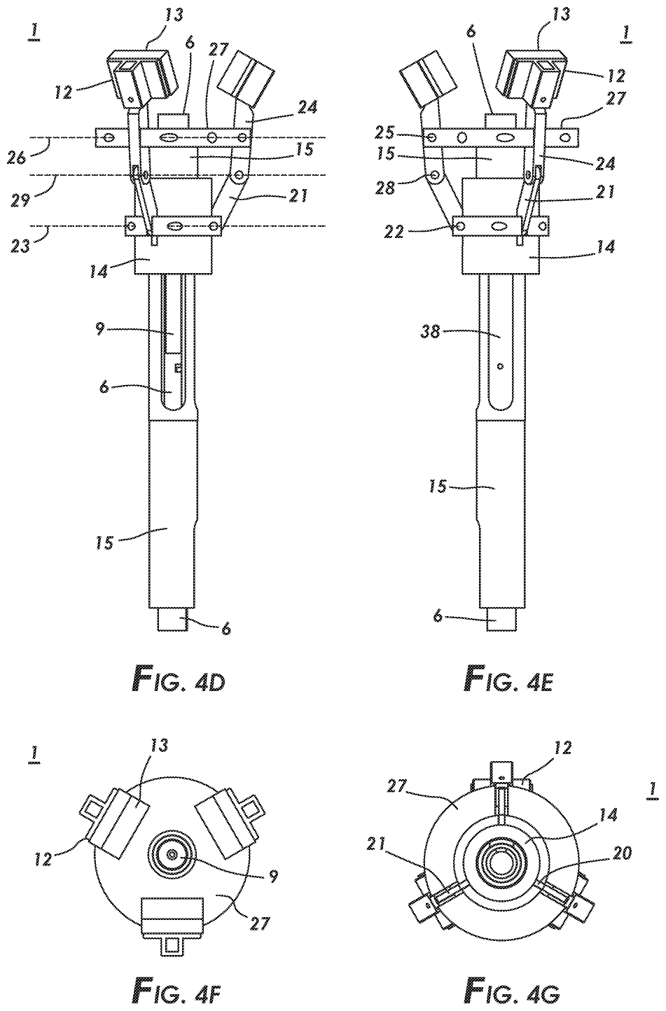

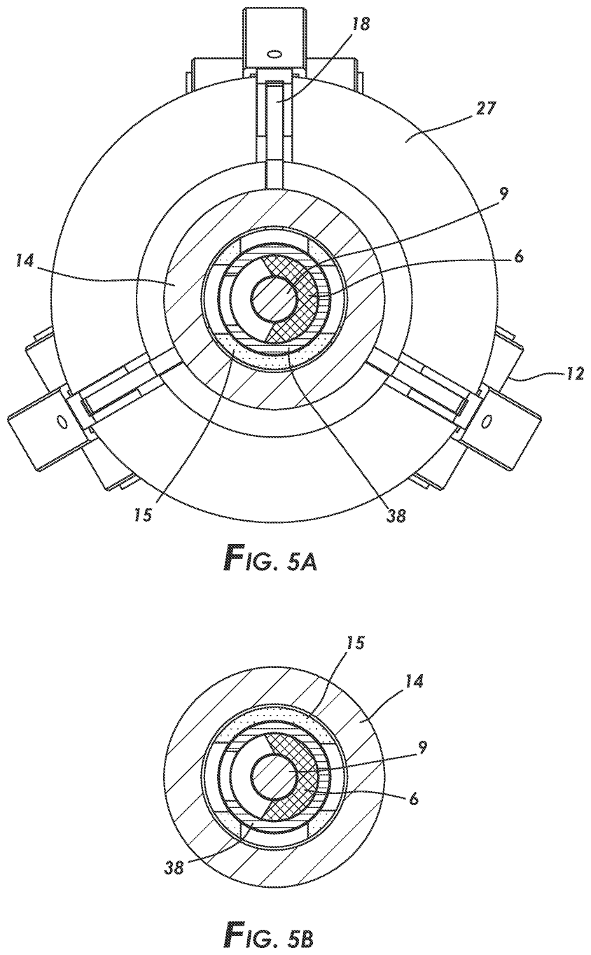

Now referring primarily to FIGS. 4A through 6B, the deseeding apparatus (1) includes a holder (5) coupled to the support surface (10) and disposed along the operating axis (11). As indicated above, the holder (5) can be configured to hold a sorrel bud (4); for this purpose, the holder (5) may include two or more grippers (12) which can contactingly engage with the sorrel bud (4) to hold it in place along the operating axis (11). As to particular embodiments, a pad (13) can be coupled to each gripper (12) such that the pad (13) contactingly engages with the sorrel bud (4) to gently hold it in place along the operating axis (11).

Each gripper (12) can dispose in radial relation to the operating axis (11), and the two or more grippers (12) may be generally horizontally aligned. Additionally, each gripper (12) can be movable in relation to the operating axis (11); in particular, each gripper (12) may move (i) inwardly (such as generally radially inwardly) toward the operating axis (11) to engage with the sorrel bud (4), and (ii) outwardly (such as generally radially outwardly) away from the operating axis (11) to release the sorrel bud (4), allowing the sorrel bud (4) to disengage from the gripper (12).

As to particular embodiments, for the purpose of movement of the grippers (12), the holder (5) can include an annular member (14) to which the grippers (12) may be coupled, whereby the annular member (14) can be movably coupled to the support surface (10). As to particular embodiments, the annular member (14) can be movably coupled to an elongate fixed tubular member (15) which may, but need not necessarily, be configured as a substantially hollow cylinder having a substantially circular cross-section. The fixed tubular member (15) can be fixedly coupled to the support surface (10), whereby a fixed tubular member longitudinal axis (or a fixed tubular member central longitudinal axis) may dispose along and/or be parallel to and/or be coincident with the operating axis (11).

As to particular embodiments, the annular member (14) can dispose about the fixed tubular member (15) via its generally central annular member aperture (16) which may receive the fixed tubular member (15) for passage therethrough; accordingly, the operating axis (11) can pass through the annular member aperture (16). For such an arrangement, the annular member aperture inner diameter can be greater than the fixed tubular member outer diameter to dispose the annular member (14) about the fixed tubular member (15) in concentric relation thereto. Operationally, the annular member (14) can reciprocally move (such as slidably move) along the fixed tubular member (15), for example toward or away from a fixed tubular member upper end (17), and correspondingly, along the operating axis (11) (which may be a generally vertical axis).

Movement of the annular member (14) along the operating axis (11) can actuate movement of each gripper (12) in relation to the operating axis (11) via an arm (18) disposed therebetween. Specifically, an arm distal end (19) can be coupled (such as fixedly coupled) to the gripper (12), and an arm proximal end (20) can be coupled to the annular member (14) to upwardly extend therefrom.

As to particular embodiments, an arm lower portion (21) (which may include the arm proximal end (20)) can be rotatably coupled to the annular member (14), such as via a pivot pin, at a lower rotation point (22) to allow the arm (18) to rotate about a lower rotation axis (23) which passes through the lower rotation point (22) upon movement of the annular member (14).

Additionally, an arm upper portion (24) (which may include the arm distal end (19) that couples to the gripper (12)) can be rotatably coupled to the fixed tubular member (15), such as via a pivot pin, at an upper rotation point (25) to allow the arm (18) to rotate about an upper rotation axis (26) which passes through the upper rotation point (25) upon movement of the annular member (14). Regarding the coupling of the arm upper portion (24) to the fixed tubular member (15), as to particular embodiments, a plate (27) can dispose therebetween, whereby the arm upper portion (24) may be rotatably coupled to the plate (27), such as via a pivot pin, and the plate (27) can be fixedly coupled to the fixed tubular member (15). As to particular embodiments, the plate (27) can dispose about the fixed tubular member (15) via its generally central aperture which may receive the fixed tubular member (15).

Moreover, the arm (18) can include a middle rotation point (28) disposed between the arm proximal and distal ends (20)(19) such that the arm lower portion (21) may be rotatably coupled to the arm upper portion (24) at the middle rotation point (28) to allow the arm lower and upper portions (21)(24) to rotate about a middle rotation axis (29) which passes through the middle rotation point (28) upon movement of the annular member (14). Of note, the arm lower and upper portions (21)(24) may, but need not, have the same or a similar length and therefore, the middle rotation point (28) may, but need not, be centrally located between the arm proximal and distal ends (20)(19).

In operation, movement of the annular member (14) along the operating axis (11) toward the fixed tubular member upper end (17), such as upward movement, can rotate the arm lower portion (21) about the lower and middle rotation axes (23)(29) to move the middle rotation point (28) outwardly (such as generally radially outwardly) away from the operating axis (11). Consequently, the arm upper portion (24) can rotate about the middle and upper rotation axes (29)(26) to move the arm distal end (19), and correspondingly the gripper (12), inwardly (such as generally radially inwardly) toward the operating axis (11) to facilitate engagement of the gripper (12) with a sorrel bud (4) disposed along the operating axis (11). Conversely, movement of the annular member (14) along the operating axis (11) away from the fixed tubular member upper end (17), such as downward movement, can rotate the arm lower portion (21) about the lower and middle rotation axes (23)(29) to move the middle rotation point (28) inwardly (such as generally radially inwardly) toward the operating axis (11). Consequently, the arm upper portion (24) can rotate about the middle and upper rotation axes (29)(26) to move the arm distal end (19), and correspondingly the gripper (12), outwardly (such as generally radially outwardly) away from the operating axis (11) to facilitate release of the sorrel bud (4), allowing the sorrel bud (4) to disengage from the gripper (12).

Movement of the holder (5) can, but need not necessarily, be driven by a first driver (30), as detailed below.

Again referring primarily to FIGS. 4A through 6B, the deseeding apparatus (1) further includes a cutter (6) coupled to the support surface (10) and disposed along the operating axis (11), whereby the cutter (6) can be movable in relation to both the holder (5) and the support surface (10). As to particular embodiments, the cutter (6) can be movably coupled to the fixed tubular member (15) which may be fixedly coupled to the support surface (10).

As indicated above, the cutter (6) can be configured to cut an opening (O) in the base (7) of the calyx (2) when the sorrel bud (4) is held by the holder (5) to provide a cut calyx (8), whereby the seed pod (3) may be accessible via the opening (O). For cutting, the cutter (6) can include an annular cutting edge (31) which may, but need not necessarily, have a generally circular cross-section; accordingly, the annular cutting edge (31) can cut an opening (O) having a generally circular cross-section. As to particular embodiments, the diameter of the annular cutting edge (31) can be greater than the diameter of the seed pod (3) at least proximate the base of the seed pod (3) which disposes above and may be engaged with or connected to the base (7) of the calyx (2). As but one illustrative example, the diameter of the annular cutting edge (31) can be about 10.5 mm.

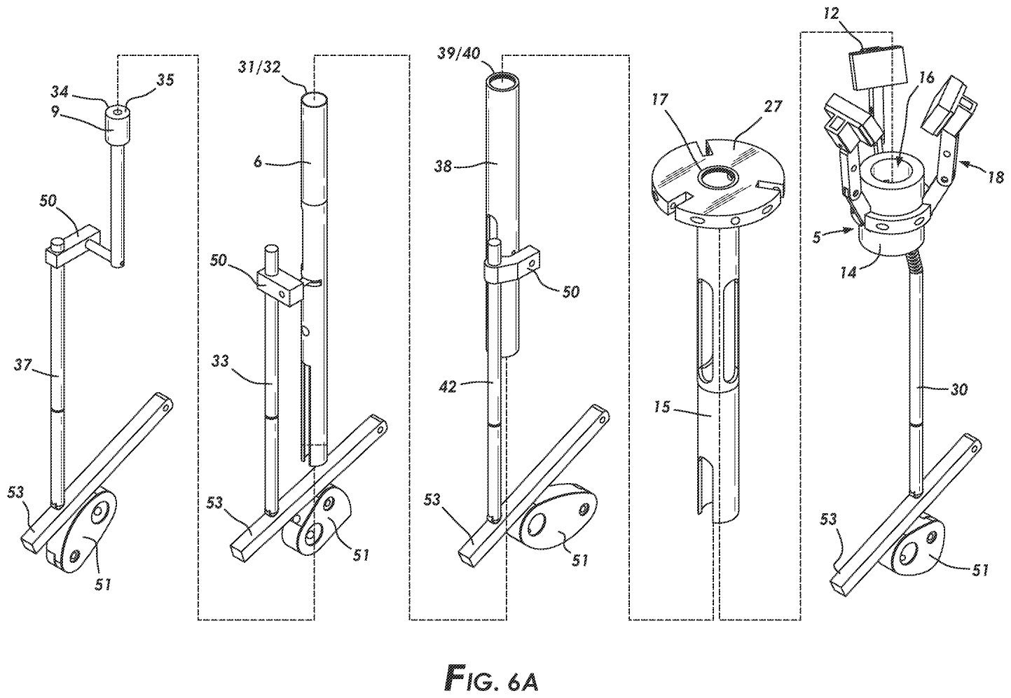

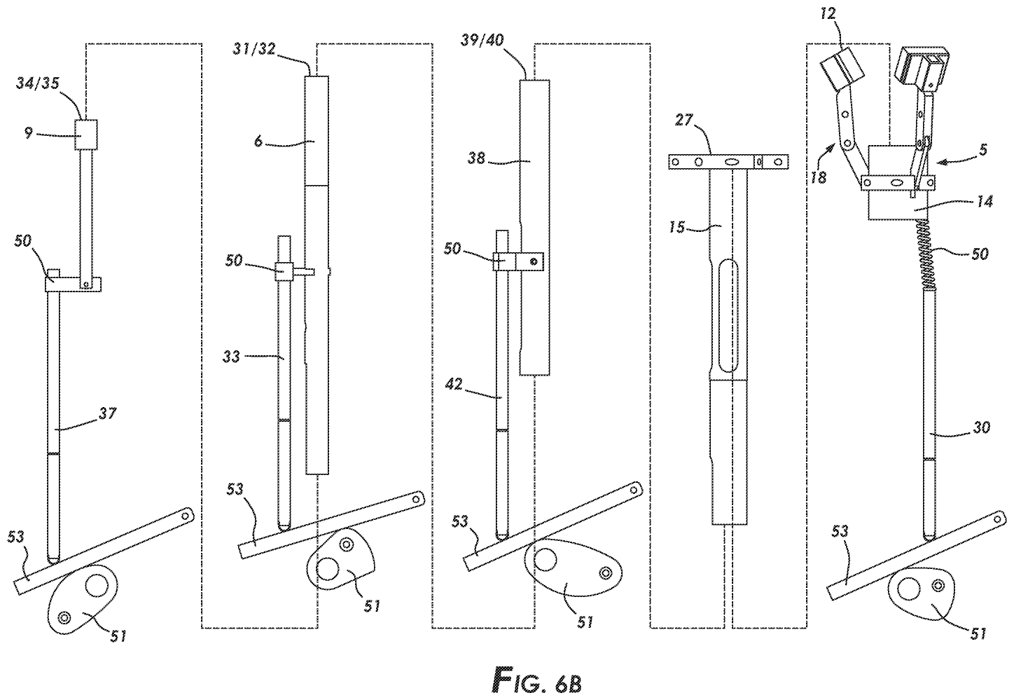

Now referring primarily to FIGS. 5A through 6B, the cutter (6) can, but need not necessarily, be configured as an elongate movable tubular member, such as a substantially hollow cylinder, having a cutter upper end (32) configured as the annular cutting edge (31). As to particular embodiments, the annular cutting edge (31) can be replaceable; for example, the annular cutting edge (31) can be removably coupled to the elongate movable tubular member such that, upon dulling, the annular cutting edge (31) can be relatively easily removed therefrom and replaced.

As to particular embodiments, the cutter (6) can dispose within the fixed tubular member (15), such as within its generally hollow passageway; accordingly, a cutter longitudinal axis (or a cutter central longitudinal axis) may dispose along and/or be parallel to and/or be coincident with the operating axis (11). For such an arrangement, the outer diameter of the cutter (6) can be lesser than the inner diameter of the fixed tubular member (15) to dispose the cutter (6) within the fixed tubular member (15) in concentric relation thereto. Operationally, the cutter (6) can reciprocally move (such as slidably move) within the fixed tubular member (15), for example toward or away from the fixed tubular member upper end (17), and correspondingly, along the operating axis (11) (which may be a generally vertical axis).

In operation, movement of the cutter (6) along the operating axis (11) toward the fixed tubular member upper end (17), such as upward movement, can cause the annular cutting edge (31) to contact the sorrel bud (4) held by the holder (5) and subsequently cut an opening (O) in the base (7) of the calyx (2) (via cutting through the base (7) of the calyx (2)) above which the seed pod (3) disposes, thereby providing a cut calyx (8) having a seed pod (3) disposed therein but no longer engaged with or connected to the calyx (2).

Movement of the cutter (6) disposed within the fixed tubular member (15) along the operating axis (11) can be driven by a second driver (33), as detailed below.

Now referring primarily to FIGS. 4A through 6B, the deseeding apparatus (1) further includes a separator (9) coupled to the support surface (10) and disposed along the operating axis (11), whereby the separator (9) can be movable in relation to both the holder (5) and the support surface (10). As to particular embodiments, the separator (9) can be movably coupled to the fixed tubular member (15) which may be fixedly coupled to the support surface (10).

As indicated above, the separator (9) can be configured to separate the seed pod (3) from the cut calyx (8) via the opening (O) when the sorrel bud (4) is held by the holder (5), whereby for said separation, the separator (9) may pass through the opening (O) and forcibly urge (or push) the seed pod (3) disposed within the cut calyx (8) out of the cut calyx (8), for example via the top (or apex) of the calyx (2).

Now referring primarily to FIGS. 5A through 6B, the separator (9) can, but need not necessarily, be configured as an elongate movable member which may take the form of a cylinder, whether substantially hollow or solid. The separator (9) can include a separator upper end (34) configured as a seed pod pushing surface (35), which may be substantially planar.

As to particular embodiments, the separator (9) can dispose within the cutter (6), such as within its generally hollow passageway, and correspondingly within the fixed tubular member (15); accordingly, a separator longitudinal axis (or a separator central longitudinal axis) may dispose along and/or be parallel to and/or be coincident with the operating axis (11). For such an arrangement, the outer diameter of the separator (9) can be lesser than the inner diameter of the cutter (6) to dispose the separator (9) within the cutter (6) and correspondingly within the fixed tubular member (15) in concentric relation thereto. Operationally, the separator (9) can reciprocally move (such as slidably move) within the fixed tubular member (15), for example toward or away from the fixed tubular member upper end (17), and correspondingly, along the operating axis (11) (which may be a generally vertical axis).

In operation, movement of the separator (9) along the operating axis (11) toward the fixed tubular member upper end (17), such as upward movement, can cause the separator (9) to pass through the opening (O); following, the seed pod pushing surface (35) may forcibly urge (or push) the seed pod (3) disposed within the cut calyx (8) out of the cut calyx (8), for example via the top (or apex) of the calyx (2). In this way, while the cut calyx (8) is held by the holder (5), the seed pod (3) can be separated therefrom.

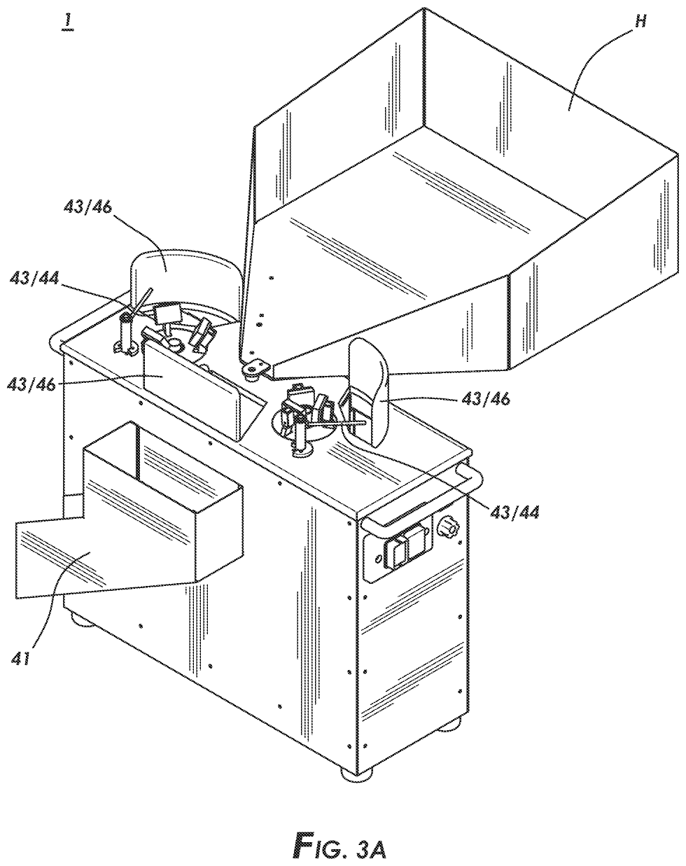

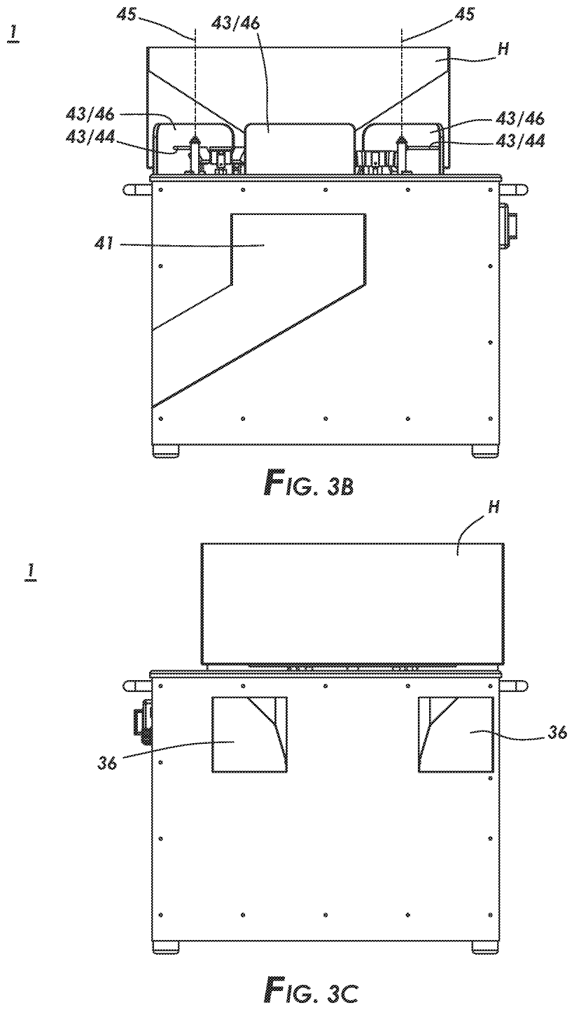

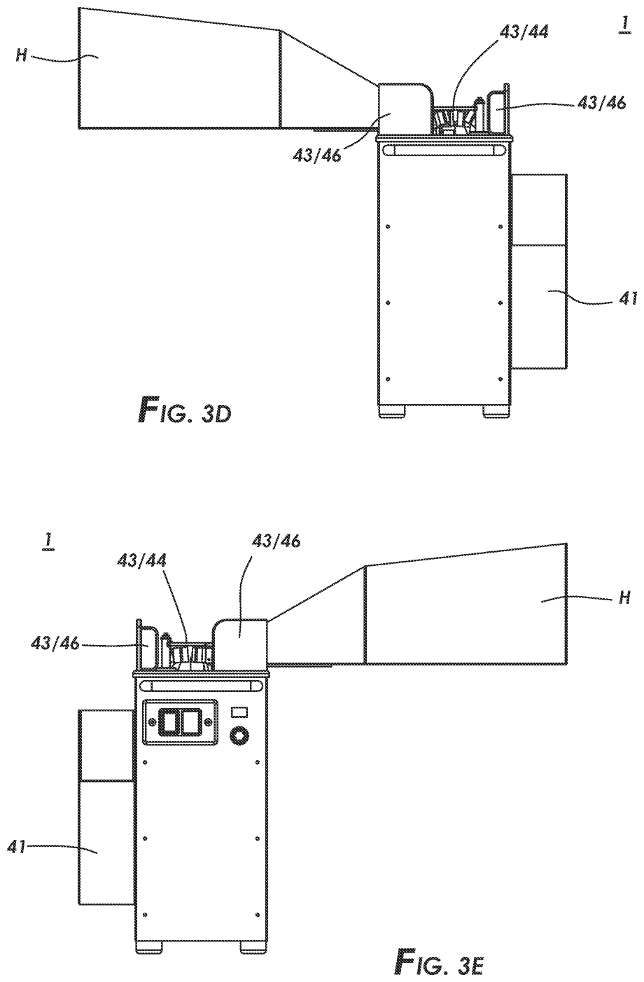

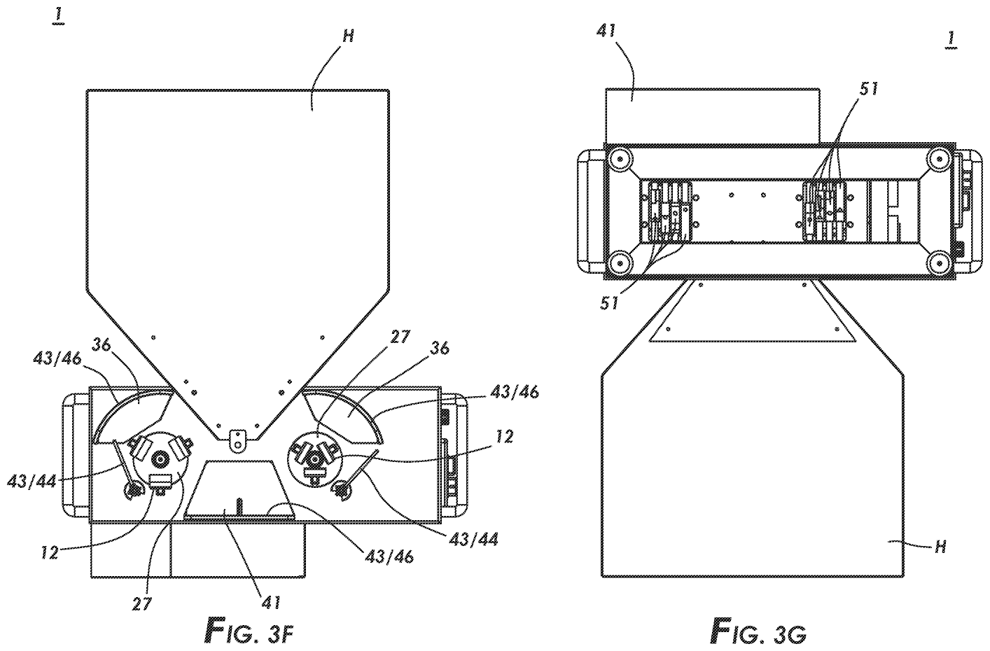

Now referring primarily to FIGS. 3C and 3F, the deseeding apparatus (1) can further include a seed pod channel (36) configured to channel the seed pods (3) following separation from the cut calyces (8), such as into a seed pod collector.

Movement of the separator (9) disposed within the fixed tubular member (15) along the operating axis (11) can be driven by a third driver (37), as detailed below.

Now referring primarily to FIGS. 4A through 6B, as to particular embodiments, the deseeding apparatus (1) can, but need not necessarily, further include an ejector (38) coupled to the support surface (10) and disposed along the operating axis (11), whereby the ejector (38) may be movable in relation to both the holder (5) and the support surface (10). As to particular embodiments, the ejector (38) can be movably coupled to the fixed tubular member (15) which may be fixedly coupled to the support surface (10). The ejector (38) can be configured to eject the cut calyx (8) from the holder (5) following separation of the seed pod (3) from the cut calyx (8) to facilitate channeling of the cut calyx (8), such as into a cut calyx collector.

Now referring primarily to FIGS. 5A through 6B, the ejector (38) can, but need not necessarily, be configured as an elongate movable tubular member, such as a substantially hollow cylinder, having an ejector upper end (39) configured as a cut calyx pushing surface (40), which may be substantially planar.

As to particular embodiments, the ejector (38) can dispose within the fixed tubular member (15), such as within its generally hollow passageway; accordingly, an ejector longitudinal axis (or an ejector central longitudinal axis) may dispose along and/or be parallel to and/or be coincident with the operating axis (11). For such an arrangement, the outer diameter of the ejector (38) can be lesser than the inner diameter of the fixed tubular member (15) to dispose the ejector (38) within the fixed tubular member (15) in concentric relation thereto. Operationally, the ejector (38) can reciprocally move (such as slidably move) within the fixed tubular member (15), for example toward or away from the fixed tubular member upper end (17), and correspondingly, along the operating axis (11) (which may be a generally vertical axis).

As to particular embodiments, the ejector (38) can dispose about the cutter (6) and the separator (9), whereby both may dispose within the generally hollow passageway of the ejector (38). For such an arrangement, the inner diameter of the ejector (38) can be greater than the outer diameter of the cutter (6) and the outer diameter of the separator (9) to dispose the ejector (38) about the cutter (6) and the separator (9) in concentric relation thereto.

In operation, movement of the ejector (38) along the operating axis (11) toward the fixed tubular member (15), such as upward movement, can cause the cut calyx pushing surface (40) to forcibly urge (or push) the cut calyx (8) out of the holder (5).

Now referring primarily to FIGS. 3B and 3F, the deseeding apparatus (1) can further include a cut calyx channel (41) configured to channel the cut calyx (8) following separation of the seed pod (3) therefrom, such as into a cut calyx collector.

Movement of the ejector (38) disposed within the fixed tubular member (15) along the operating axis (11) can, but need not necessarily, be driven by a fourth driver (42), as detailed below.

Now referring primarily to FIGS. 3A, 3B, and 3F, as to particular embodiments, the deseeding apparatus (1) can, but need not necessarily, further include one or more directors (43) coupled to the support surface (10), whereby a director (43) may be configured to direct an ejected cut calyx (8) into the cut calyx channel (41).

As to particular embodiments, a director (43) can be movable in relation to the support surface (10), whereby movement of the director (43) may direct an ejected cut calyx (8) into the cut calyx channel (41). As but one illustrative example, the director (43) can comprise a directing arm (44) rotatably coupled to the support surface (10) proximate the holder (5), such as above the holder (5), whereby upon rotation of the directing arm (44) about a directing arm rotation axis (45), the directing arm (44) may contact the cut calyx (8) and direct it away from the holder (5) and toward the cut calyx channel (41). As would be understood, rotation of the directing arm (44) can be driven by a motor or the like.

As but a second illustrative example, the director (43) can comprise flowing gas, such as air, coupled to the support surface (10) such that the gas flows proximate the holder (5), such as above the holder (5), in a desired flow path and/or direction (not shown). Upon flowing of the gas in the desired flow path and/or direction, the flowing gas can contact the cut calyx (8) and direct it away from the holder (5) and toward the cut calyx channel (41).

As to other particular embodiments, a director (43) can be fixed in relation to the support surface (10). As but one illustrative example, the director (43) can comprise a wall (46) at least partially bounding the holder (5), whereby upon contact with the wall (46), such as following contact with a directing arm (44) or flowing gas, the cut calyx (8) may “rebound” and be directed toward the cut calyx channel (41). Thus, in a way, the wall (46) can function like a basketball backboard.

Movement of each of the holder (5), the cutter (6), the separator (9), and the ejector (38) can be automatic or driven by a machine, which may be in contrast to being driven by human power (thus, manual labor). Said another way, movement of each of the holder (5), the cutter (6), the separator (9), and the ejector (38) can be driven by non-manual power.

Now referring primarily to FIGS. 2B, 2C, and 6A through 7D, movement of the holder (5) can be driven by a first driver (30), movement of the cutter (6) can be driven by a second driver (33), movement of the separator (9) can be driven by a third driver (37), and movement of the ejector (38) can be driven by a fourth driver (42), whereby each driver (30)(33)(37)(42) may be operably coupled to a motor (47), such as an electric motor which converts electrical energy into mechanical energy for actuating movement.

Again referring primarily to FIGS. 2B, 2C, and 6A through 7D, as to particular embodiments, each driver (30)(33)(37)(42) can be operably coupled to the same motor (47); thus, one motor (47) may drive movement of the holder (5), the cutter (6), the separator (9), and the ejector (38). In more detail, the motor (47) can drive rotation of an axle (48) about an axle rotation axis (49) which may drive movement of each driver (30)(33)(37)(42) and thus, movement of the corresponding holder (5), cutter (6), separator (9), or ejector (38).

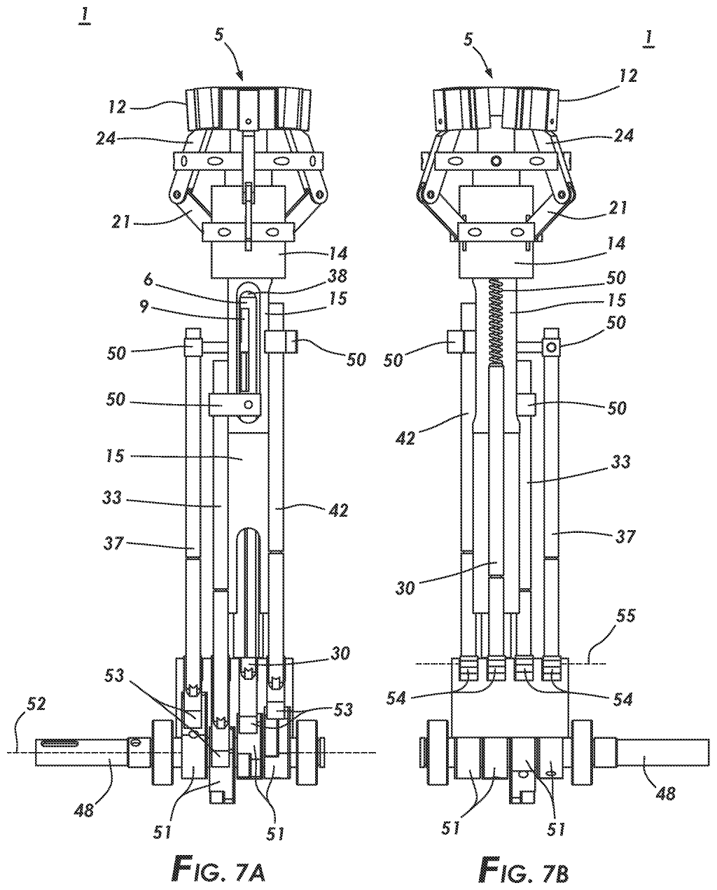

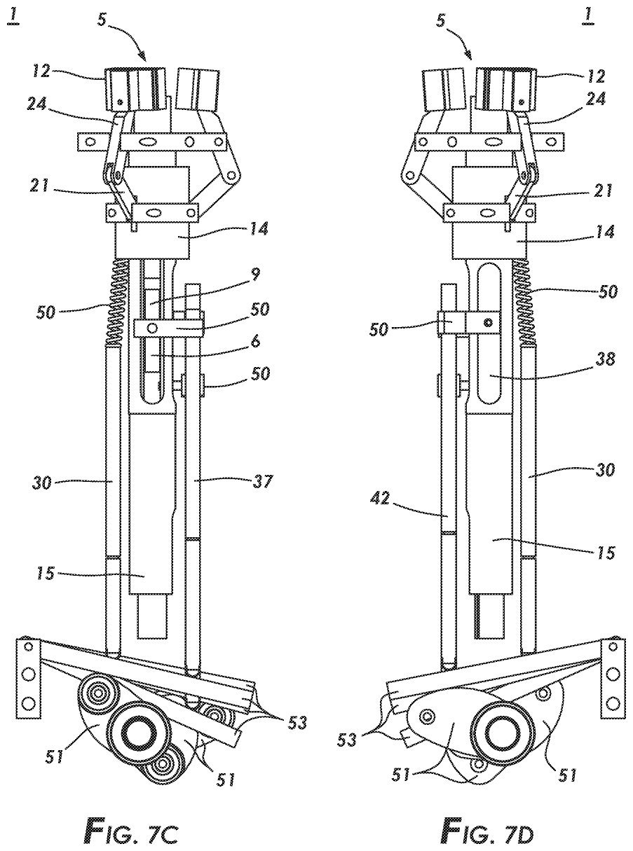

Now referring primarily to FIGS. 6A through 7D, as to particular embodiments, each driver (30)(33)(37)(42) can be configured as a rigid elongate member, for example but not limited to a rod, having a driver longitudinal axis which may be generally parallel to the operating axis (11). Upon rotation of the axle (48) about the axle rotation axis (49), the driver (30)(33)(37)(42) can reciprocally move in generally parallel relation to the operating axis (11) (which may be a generally vertical axis). Typically, movement of a driver (30)(33)(37)(42) toward the fixed tubular member upper end (17) can be considered upward movement which subsequently drives upward movement of the corresponding holder (5), cutter (6), separator (9), or ejector (38) along the operating axis (11) toward the fixed tubular member upper end (17). Likewise, movement of a driver (30)(33)(37)(42) away from the fixed tubular member upper end (17) can be considered downward movement which subsequently drives downward movement of the corresponding holder (5), cutter (6), separator (9), or ejector (38) along the operating axis (11) away from the fixed tubular member upper end (17).

Now referring primarily to FIGS. 7A through 7D, as to particular embodiments, each driver (30)(33)(37)(42) can be coupled to the corresponding holder (5), cutter (6), separator (9), or ejector (38) via a suitable connector (50).

As to particular embodiments, a connector (50) can fixedly couple the driver (30)(33)(37)(42) to the corresponding holder (5), cutter (6), separator (9), or ejector (38). As but one illustrative example, a connector (50) can fixedly couple the second driver (33) to the cutter (6). As but another illustrative example, a connector (50) can fixedly couple the third driver (37) to the separator (9). As but another illustrative example, a connector (50) can fixedly couple the fourth driver (42) to the separator (9).

Now referring primarily to FIGS. 7B through 7D, as to particular embodiments, the first driver (30) can be coupled to the holder (5) and specifically, to the annular member (14) via an elastic connector (50), such as a spring, which may facilitate relatively gentle inward movement of the grippers (12) toward the operating axis (11) for gentle engagement with the sorrel bud (4) and gentle holding of the sorrel bud (4) in place.

Now referring primarily to FIGS. 7A through 7D, as to particular embodiments, each driver (30)(33)(37)(42) can be coupled to the axle (48) via a cam (51) which, upon rotating about a cam rotation axis (52), may convert the rotational movement of the axle (48) into reciprocal movement of the drivers (30)(33)(37)(42) and thus, reciprocal movement of the corresponding holder (5), cutter (6), separator (9), or ejector (38) along the operating axis (11). As to particular embodiments, each cam (51) can be configured as a generally flat plate or disk with a specially shaped, eccentric perimeter, whereby the size and shape of the perimeter may affect the travel distance of the driver (30)(33)(37)(42) and the timing of its reciprocal motion. As to particular embodiments, the size and/or shape of the perimeter of the cam (51) for each driver (30)(33)(37)(42) can be different.

Again referring primarily to FIGS. 7A through 7D, as to particular embodiments, the contours of the perimeter of the cam (51) can influence the motion of a follower (53). As to particular embodiments, the follower (53) can be configured as a rigid elongate member having a follower longitudinal axis which may dispose in angled relation to the driver longitudinal axis. The follower (53) can (i) dispose between the cam (51) and the driver (30)(33)(37)(42), and (ii) be rotatably coupled to the support surface (10) proximate a follower end (54) such that the follower (53) may rotate about a follower rotation axis (55) upon movement of the cam (51).

In operation, the motor (47) can drive rotation of the axle (48) about the axle rotation axis (49) which drives rotation of the cam (51) about the cam rotation axis (52) which drives rotation of the follower (53) about the follower rotation axis (55) which drives reciprocal movement of the driver (30)(33)(37)(42) which drives reciprocal movement of the corresponding holder (5), cutter (6), separator (9), or ejector (38) along the operating axis (11).

As shown in the examples of the Figures, as to particular embodiments, a pair of the present inventive deseeding apparatuses (1), for example first and second deseeding apparatuses (1), can be disposed proximate one another and/or be housed together such that two sorrel buds (4) can be deseeded at substantially the same time and in an alternating fashion, which may be especially efficient. For example, the first and second deseeding apparatuses (1) can have generally opposite timing for the movement of the holder (5), the cutter (6), the separator (9), and the ejector (38); accordingly, a first sorrel bud (4) can be loaded into the holder (5) of the first deseeding apparatus (1), such as from a hopper (H), for deseeding and thereafter, a second sorrel bud (4) can be loaded into the holder (5) of the second deseeding apparatus (1), such as from the hopper (H), for deseeding. After the first sorrel bud (4) is deseeded, a third sorrel bud (4) can be loaded into the holder (5) of the first deseeding apparatus (1), such as from the hopper (H), for deseeding and, after the second sorrel bud (4) is deseeded, a fourth sorrel bud (4) can be loaded into the holder (5) of the second deseeding apparatus (1), such as from the hopper (H), for deseeding, and so on and so forth. For such sequential loading, the first and second deseeding apparatuses (1) can be disposed relatively close to one another such that if the holders (5) are manually loaded, the loader can either use one hand to alternately load each holder (5) or can use both hands to alternately load each holder (5).

In addition to being disposed relatively close to one another, as to particular embodiments, the first and second deseeding apparatuses (1) can share one or more components; as but one illustrative example, the first and second deseeding apparatuses (1) can share a motor (47) which can drive the alternate movement of the corresponding holders (5), cutters (6), separators (9), and ejectors (38) of the first and second deseeding apparatuses (1).

A method of making a particular embodiment of the present inventive deseeding apparatus (1) for separating a calyx (2) and a seed pod (3) of a sorrel bud (4) can include coupling a holder (5) to a support surface (5), the holder (5) configured to hold the sorrel bud (4); movably coupling a cutter (6) to the holder, the cutter (6) configured to cut an opening (O) in a base (7) of the calyx (2) to provide a cut calyx (8); movably coupling a separator (9) to the holder (5), the separator (9) configured to separate the seed pod (3) from the cut calyx (8) via the opening (O); and operatively coupling a means for automatic movement to at least the cutter (6) and the separator (9).

As to particular embodiments, the method can further include movably coupling an ejector (38) to the holder (5), the ejector (38) configured to eject the cut calyx (8) from the holder (5) following separation of the seed pod (3) from the cut calyx (2).

The method can further include coupling one or more additional components described above and/or in the claims to the support surface (5).

A method of using a particular embodiment of the present inventive deseeding apparatus (1) to separate a calyx (2) and a seed pod (3) of a sorrel bud (4) can include holding the sorrel bud (4) with a holder (5), automatically cutting an opening (O) in a base (7) of the calyx (2) with a cutter (6) while the sorrel bud (4) is held by the holder (5) to provide a cut calyx (8); and automatically separating the seed pod (3) from the cut calyx (8) via the opening (O) with a separator (9) while the sorrel bud (4) is held by the holder (5).

As to particular embodiments, the method can further include ejecting the cut calyx (8) from the holder (5) following separation of the seed pod (3) from the cut calyx (2).

The method can further include using one or more additional components described above and/or in the claims to facilitate separation of the seed pod (3) from the calyx (2) of a sorrel bud (4).

While described above with reference to a sorrel bud (4) and its seed pod (3), the present inventive deseeding apparatus (1) can be used for separating a seed or seed pod from a numerous and wide variety of other plants, and thus is not limited to use with only roselle.

Where a component is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods, and apparatus have been described herein for the purpose of illustration. These are only examples. The technology provided herein can be applied to systems other than the example systems described above. Many alterations, modifications, additions, omissions, and permutations are possible within the practice of this invention. This invention includes variations on described embodiments that would be apparent to a person of ordinary skill in the art, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “particular embodiments.” Such features are not mandatory and may not be present in all embodiments. Embodiments of the invention may include zero, any one, or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “particular embodiments” possess feature A and “particular embodiments” possess feature B should be interpreted as an express indication that the inventors also contemplate embodiments which combine features A and B (unless the description states otherwise or features A and B are fundamentally incompatible).

As can be easily understood from the foregoing, the basic concepts of the present invention may be embodied in a variety of ways. The invention involves numerous and varied embodiments of an apparatus for deseeding a sorrel bud, and methods of making and using the same.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “driver” should be understood to encompass disclosure of the act of “driving”—whether explicitly discussed or not—and, conversely, were there effectively disclosure of the act of “driving,” such a disclosure should be understood to encompass disclosure of a “driver” and even a “means for driving.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the systems and methods for an apparatus for deseeding a sorrel bud herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application, if any, provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. An apparatus for separating a calyx and a seed pod of a sorrel bud, comprising:
a holder configured to hold said sorrel bud;
a cutter movable in relation to said holder, said cutter configured to cut an opening in a base of said calyx to provide a cut calyx; and
a separator movable in relation to said holder, said separator configured to separate said seed pod from said cut calyx via said opening;
wherein movement of said cutter and said separator is automatic.

2. The apparatus of claim 1, said holder coupled to a support surface and disposed along an operating axis.

3. The apparatus of claim 2, said holder movably coupled to a fixed tubular member which is fixedly coupled to said support surface.

4. The apparatus of claim 3, wherein a fixed tubular member longitudinal axis of said fixed tubular member disposes along said operating axis.

5. The apparatus of claim 3, said holder comprising at least two grippers configured to contactingly engage with said sorrel bud to hold it in place.

6-7. (canceled)

8. The apparatus of claim 7, each said gripper movable in relation to said operating axis.

9-18. (canceled)

19. The apparatus of claim 4, said cutter movably coupled to said fixed tubular member.

20-22. (canceled)

23. The apparatus of claim 19, wherein said cutter disposes within said fixed tubular member.

24-25. (canceled)

26. The apparatus of claim 23, wherein a cutter longitudinal axis of said cutter disposes along said operating axis.

27. The apparatus of claim 26, wherein in operation, said cutter reciprocally moves within said fixed tubular member and correspondingly along said operating axis.

28-29. (canceled)

30. The apparatus of claim 23, said separator movably coupled to said fixed tubular member.

31. (canceled)

32. The apparatus of claim 30, wherein said separator disposes within said cutter and correspondingly within said fixed tubular member.

33-34. (canceled)

35. The apparatus of claim 32, wherein a separator longitudinal axis of said separator disposes along said operating axis.

36. The apparatus of claim 35, wherein in operation, said separator reciprocally moves within said fixed tubular member and correspondingly along said operating axis.

37-39. (canceled)

40. The apparatus of claim 32, further comprising an ejector movable in relation to said holder.

41. (canceled)

42. The apparatus of claim 40, said ejector movably coupled to said fixed tubular member.

43. (canceled)

44. The apparatus of claim 42, wherein said ejector disposes within said fixed tubular member.

45-46. (canceled)

47. The apparatus of claim 44, wherein an ejector longitudinal axis of said ejector disposes along said operating axis.

48. The apparatus of claim 47, wherein in operation, said ejector reciprocally moves within said fixed tubular member and correspondingly along said operating axis.

49-74. (canceled)

75. The apparatus of claim 44, wherein:
movement of said holder is driven by a first driver;
movement of said cutter is driven by a second driver;
movement of said separator is driven by a third driver;
movement of said ejector is driven by a fourth driver; and
said first, said second, said third, and said fourth drivers are operably coupled to an axle of a motor.
